(19) United States
(12) Patent Application Publication
(10) Pub. No.: US 2007/0058704 A1
(43) Pub. Date: Mar. 15, 2007

(54) Dsl modem and transformer

(75) Inventors: Neil McNeill Alford, London (GB); Ener Orlando Salinas Flores, London (GB); Stavros Dimitriou, London (GB)

Correspondence Address: ANTHONY R. BARKUME, 20 GATEWAY LANE, MANORVILLE, NY, 11949, US

(73) Assignee: SOUTH BANK UNIVERSITY ENTERPRISES LTD., London (GB)

(21) Appl. No.: 10/596,192

(22) PCT Filed: Dec. 3, 2004
(86) PCT No.: PCT/GB04/50035

§ 371 Date: Aug. 31, 2006

(30) Foreign Application Priority Data
Dec. 3, 2003 (GB) 0328072.4

(51) Int. Cl. H04L 5/16

(52) U.S. Cl. 375/222

(57) ABSTRACT

A digital subscriber line (DSL) modem comprising a line interface transformer (40; 50; 80; 100; 130) having a primary circuit (42; 52; 81; 131) for coupling to a transmission line and a secondary circuit (44; 56; 82; 132) for outputting a signal transmitted over said transmission line, each circuit being formed of a continuous electrically conductive material and in which the primary circuit defines a first plane and the secondary circuit defines a second plane, said first and second planes substantially parallel to one another.

### FIELD OF THE INVENTION

The present invention relates to a Digital Subscriber Line (DSL) modem, a transformer for use in such a modem, a method of transmitting electronic data, a method of manufacturing a DSL modem and to a coreless transformer.

### BACKGROUND OF THE INVENTION

Michael Faraday invented the transformer in 1831. It is noted that the original designs of the transformer were intended mainly for power applications. The design is bulky and cumbersome as it involves a nucleus of ferrite surrounded by many turns of copper. This design has been kept with very little variation for more than a century in spite of a manifold of uses ranging from high voltage to sophisticated micro-electronic equipment.

In recent times complex DSP techniques and coding have been developed to utilise the telephone lines of the existing telephone network or Plain Old Telephone System (POTS), for transmission of electronic data at high data rates (of the order of megabits per second). A conventional telephone transmission line typically comprises a pair of copper conductors that connect a telephone set to the nearest Central Office (CO or telephone network operator), digital loop carrier equipment, remote switching unit or any other equipment serving as the extension of the services provided by the CO. This pair of copper conductors is frequently referred to as a “twisted pair”. A number of such twisted pairs are generally bundled together within the same cable binder group.

Transmission of electronic data by this means is generally referred to as Digital Subscriber Line or “DSL”. A DSL is established between two modems coupled by a twisted copper pair, one modem located at the user (Customer Premises Equipment—CPE) and the other located at the CO. A family of different standards have been developed under DSL, generally referred to as “xDSL”, and new standards are under development Variations of DSL technology in the family include SHDSL (symmetric high-bit-rate DSL), HDSL2 (second-generation high bit-rate DSL), RADSL (rate adaptive DSL), VDSL (very high-bit-rate DSL), and ADSL (asymmetric DSL). The frequencies used for transmission of electronic data using DSL technology ranges from about 25 kHz up to several MHz.

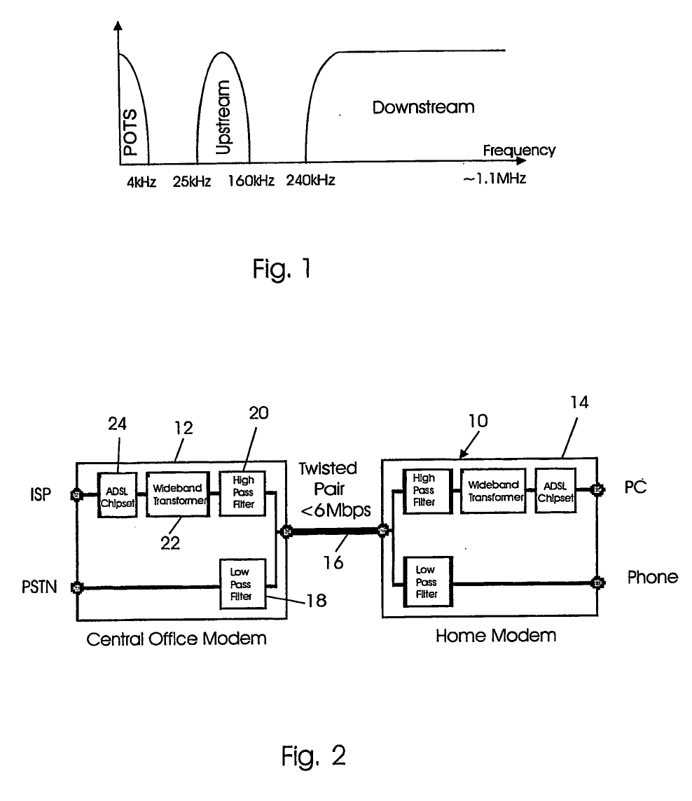

Some DSL technologies, such as ADSL, have the advantage that ordinary voice data transmissions i.e. POTS can share the same twisted pair with electronic data transmissions. FIG. 1 shows how the frequency spectrum is divided for ADSL. A lower frequency band (0-4 kHz) is used for voice data, while an upper frequency band (25 kHz-1.1 MHz) is used for electronic data. The upper frequency band is further split into two bands, one for upstream transmission (i.e. user to CO) and the other for downstream transmission (i.e. CO to user). The downstream transmission band is much larger than the upstream transmission band as most users will download far more data from the Internet than they will upload. 256 frequency carriers placed at 4.3125 kHz intervals provide a bandwidth of approximately 1.1 MHz for the upstream and downstream transmission bands. The actual downstream data rate achieved by ADSL is dependent on a large number of factors including length of the twisted pair, its wire gauge, presence of bridged taps and cross-coupled interference.

The modems at each end of the twisted pair employ filters to filter either the data transmission band or the voice band for subsequent processing.

For many years in POTS a line interface transformer has been used as an interface between the telephone line and the electric circuits in the users home or office. This interface provides safety for the user by isolating the twisted pair from the user to prevent large voltages induced in the twisted pair (e.g. lightning strike) from being transmitted to the circuits in the user's home.

With the advent of DSL technology, several additional requirements have been placed on such line interface transformers including: provision of a flat frequency response over a much wider bandwidth; excellent signal transmission properties (ideally 1:1), impedance matching and minimal insertion loss. The ability of the transformer to faithfully reproduce the input signal is of particular importance in view of the sensitive nature of the DSL signal.

Up to the present day transformers for use in DSL modems have been of the traditional type in which an iron core is used to couple the magnetic flux from the copper primary winding to the copper secondary winding. This is because, at DSL frequencies and particularly the low frequencies, the skin depth in which 1/e or 63% of the primary winding magnetic field is absorbed by the secondary winding ranges from 0.667 mm at 10 kHz to 0.067 mm at 1 MHz in copper. The remainder of the available energy is not absorbed and passes through a conductor of these respective thicknesses. Thus in order to obtain a good flux linkage or coefficient of coupling between the primary and secondary windings it is necessary to (1) have enough material present in the secondary winding to absorb the energy from the primary winding and (2) to ensure that the magnetic flux from the primary winding cuts that material as it expands and collapses. This is particularly important in DSL transformers where there is usually a 1:1 winding ratio. Any flux leakage is highly undesirable, as the signal will not be reproduced without distortion.

As mentioned above, the traditional and well-accepted solution to this problem in the field of transformers for use in DSL modems is to use an iron core transformer. For example ADSL transformers have line-side inductances ranging from a few hundreds of microhenries to a few millihenries. They do not need to carry DC; however they are gapped to control their inductance within a ±5% to ±10% range. Leakage inductances are roughly proportional to line-side inductances, ranging from a few microhenries to a few tens of microhenries. Echo cancellation is employed in ADSL systems in the frequency range where the upstream and downstream signals overlap, making distortion a critical factor. Typical distortion requirements are −85 dB maximum THD for the CPE end and −80 dB THD for the CO end; both measured with a 15 Vp-p signal at 100 KHz.

DSL is becoming the most popular option for both businesses and consumers for high-speed communications and Internet access. The major success of DSL technology worldwide places all telecom manufacturers under pressure for next-generation DSL products. In order to maintain and improve DSL prevalent availability, service quality and performance, the main priority is to design analogue circuitry with high signal reliability and low power operation. Therefore, analogue design community faces new challenges of requirements for analogue front-end building blocks including a crucial component, the line interface transformer. All these parameters affect dramatically to the overall performance of the transmission and the quality of service.

However typical ADSL transformers measure about 1 cm by 1 cm by 1 cm i.e. an overall aspect ratio of the device of approximately 1:1 (a three-dimensional object with a shape resembling that of a cube). Unfortunately this arrangement is bulky, heavy and expensive to manufacture needing a large amount of raw material and skilled labour to assemble the parts. The continuing pressure for smaller electronic devices is pressing manufacturers to find a smaller and lighter replacement for the traditional transformer as used in DSL modems that does not rely on a ferrite core, but which does not result in lower performance.

A DSL transformer is described in our PCT patent application PCT/GB2004/050011, namely a bifilar transformer having the same applications as the present invention but completely different structure, complexity, and coupling and therefore it is considered as an entirely different device. The bifilar transformer consisted of a multi-layered design in a vertical distribution of a number of layers with the use of two 30-turn coils, one for the primary and one for the secondary, in a horizontal parallel distribution. This construction makes use of horizontal magnetic coupling between inter-winding primary and secondary loops along with the vertical magnetic coupling. A transformer according to the present invention makes use of a number of single 60-turn coils implementing a multi-layered (stacked) design and it primarily makes use of vertical magnetic coupling.

### SUMMARY OF THE PRESENT INVENTION

Preferred embodiments of the present invention are based on the insight that it is possible to replace the ferrite core in a line interface transformer designed to operate at DSL frequencies with a geometrical winding structure substantially without degradation in performance. A particular advantage is that the geometrical structure is smaller (in one dimension at least) and lighter than the equivalent conventional DSL ferrite core transformer. Surprisingly, the applicant has found that the resonant effects some embodiments of the stacked transformer arrangements disclosed herein can be mitigated through appropriate structure and geometry rather than through external circuit components, making such transformers attractive for application in DSL technology where a flat frequency response over a wide bandwidth is of importance.

According to the invention there is provided a transformer which comprises at least one substantially planar primary circuit and at least one substantially planar secondary circuit each circuit being formed of a continuous electrically conductive material and in which the primary and secondary circuits are substantially parallel and spaced apart in the vertical plane. By vertical plane is meant at right angles to the plane of the primary or secondary circuits which, for convenience is called the horizontal plane.

The transformer preferably comprises a primary circuit and a secondary circuit each circuit being formed of a continuous electrically conductive material and the circuits are in the form substantially parallel spirals of the material. The spiral can be circular, elliptical, square, rectangular, oval or non-regular.

The spiral preferably conforms substantially to a spiral formed by the polar equation r(θ)=αθ, where θ is the angle in polar coordinates, r is the radius and α is a constant that regulates the number of turns and the spacing. Preferably the number of turns in the spiral is at least five.

There can be a plurality of primary and secondary circuits and all the primary circuits can be adjacent to each other and separated by an air gap from the secondary circuits that are arranged adjacent to each other. Alternatively the primary and the secondary circuits can be arranged to be interleaved with each other so they alternate, with an air gap between each primary and secondary circuit.

A way to maintain flux linkage and transformer capability is through a compact stacked arrangement, namely, if the primary and secondary are in two vertically separated parallel planes. This leads to two vertically separated spiral coils (hence “stacked” transformer). A connection in series of the coils generates a stacked structure and improves the signal transmission. The arrangement increases the height of the device. However the total aspect ratio defined as diameter: height of the device is kept relatively large and for this reason it represents a quasi-planar transformer (QPT).

In order to improve this component, a 2D solution for replacing the transformer function consists of a planar structure with two coils in stacked design (one on top of the other, both isolated) characterised by the absence of a ferromagnetic element.

There can be typically at least 10 layers or more for both primary and secondary, using single coils in series arrangements, one for the primary and one for the secondary, and generally the more layers the better the transformer operation.

Features of the invention are that there is an absence of a ferromagnetic element and the production of a very low aspect ratio transformer device, e.g. an aspect ratio of 1:5 or less and preferably with an aspect ratio less than 1:10 or less than 1:20. The invention provides a transformer without a ferromagnetic (usually ferrite) element with low aspect ratio. It has the additional advantage in that the manufacturing process is amenable to planar film techniques and also to multilayered fabrication techniques. The substance of the invention is that a 3D ferrite core based design had been replaced by a 2D multilayered design in which all planar layers are connected each other in series. This invention is particularly useful in, but not restricted to, Asymmetric Digital Subscriber Line ADSL and Very High Data rate DSL (VDSL) applications. Surprisingly, it is found that removal of the ferromagnetic element and a low physical aspect ratio in the device is possible and therefore transforming action is observed. The avoidance of a ferromagnetic element (such as ferrite) eases the construction operation.

According to another aspect of the present invention there is provided a digital subscriber line (DSL) modem comprising a line interface transformer having a primary circuit for coupling to a transmission line and a secondary circuit for outputting a signal transmitted over said transmission line, each circuit being formed of a continuous electrically conductive material and in which the primary circuit defines a first plane and the secondary circuit defines a second plane, said first and second planes substantially parallel to one another. It will be appreciated that plane is a term of convenience and that each circuit does not lie solely within one plane. Preferably said first plane is spaced-apart from said second plane. This results in a structure in which the primary and secondary circuits are spaced-apart in the vertical plane. Such a transformer makes use of vertical magnetic coupling and it may contain a large number of windings (several hundreds) generating inductance, capacitance and resistance. Such characteristics generate a resonant frequency and therefore appropriate methods have been found that can mitigate the resonant behaviour providing a good ADSL transformer operation. These methods are related to external circuitry and/or transformer geometry and structure.

Advantageously, said line interface transformer comprises alternating layers of said primary circuit and said secondary circuit There may be more than one circuit of each type per layer.

Preferably, there are a plurality of first and second planes each plane forming a layer and wherein said primary circuit comprises a plurality of substantially parallel layers and said secondary circuit comprises a plurality of substantially parallel layers.

Advantageously, layers of said primary circuit are adjacent one another and layers of said secondary circuit are adjacent one another, said primary and secondary circuits separated by a gap. The gap is preferably no greater than needed for insulation purposes between the circuits, and preferably not more than 0.1 mm. This gap might be an air gap.

In one embodiment said primary circuit layers form a primary circuit stack and said secondary circuit layers form a secondary circuit stack, said primary circuit stack and said secondary circuit stacked one adjacent the other. There may be a gap between the two stacks. The gap can be an air gap. The size of the gap may be between 0.1 mm to 0.5 mm depending on the bandwidth in which the transformer is to be used. By adjusting the size of the gap the capacitance of the transformer can be adjusted, thereby shifting the resonance.

In another embodiment layers of said primary circuit are interleaved with layers of said secondary circuit.

Preferably, separation between two layers is not more than 0.5 mm. This helps to ensure good transformer action over the frequency band of interest.

Advantageously, layers of said primary circuit are connected in series or parallel. A series connection between respective circuits in each layer is preferred as this helps to increase the inductance.

Preferably, layers of said secondary circuit are connected in series or parallel. A series connection between respective circuits in each layer is preferred as this helps to increase the inductance.

The frequency response curve of the transformer improves with increasing numbers of layers of circuits. Advantageously, the line interface transformer further comprises at least ten layers of said plurality of substantially parallel layers of said primary circuit, and at least ten layers of said plurality of substantially parallel layers of said secondary circuit. This has been found to produce good results for the purposes of signal transmission over the transformer, with between 20 and 40 layers of each more preferable, and 30 layers offering a good compromise between size and weight on the one hand and performance on the other.

Preferably, a number of turns of each circuit is at least ten. Still more preferably there are between about 50 and 70 turns per circuit, with about 60 having produced good results.

Advantageously, the DSL modem further comprises damping means for da&Wing resonance in said secondary circuit. The damping means may be dynamic or passive. In one embodiment the damping means is a planar metallic member such as a plate or foil. In another embodiment the damping means may be a passive primary circuit and/or secondary circuit that has been short-circuited to provide an isolated conductive path in which voltages will be induced to provide a damping effect. Such an arrangement offers particular simplicity from the manufacturing perspective.

Preferably, said damping means is positioned on one side of said line interface transformer. One side means adjacent one of the planar circuits.

Advantageously, said damping means is positioned on both sides of said line interface transformer.

Preferably, said damping means is positioned in between said primary and secondary circuits. This arrangement has been found to produce excellent results with very few circuit layers. An arrangement of damping means adjacent primary circuit adjacent secondary circuit may be repeated throughout the transformer structure. In one embodiment such a structure has at least ten primary circuit layers and at least ten secondary circuit layers. The number of primary circuit layers may or may not be the same as the number of secondary circuit layers. Increasing the number of layers will extend upper end of the frequency bandwidth of the transformer.

In one embodiment said damping means comprises a metal such as aluminium. In another embodiment the metal may be a ferromagnetic material such as iron.

Advantageously, said primary circuit and said secondary circuit are in the form substantially parallel spirals of the conductive material defining substantially different planes.

Preferably, the spiral is substantially circular, elliptical, square, rectangular, oval or non-regular.

Advantageously, the spiral conforms substantially to a spiral formed by the polar equation r(θ)=αθ, where θ is the angle in polar coordinates, r is the radius and α is a constant that regulates the number of turns and the spacing.

Preferably, the line interface transformer has an aspect ratio defined as diameter to width of 1:5 or more. Thus the height of the transformer is greatly reduced compared to existing DSL transformers.

Advantageously, said line interface transformer does not comprise ferromagnetic core. Enabling removal of this component greatly reduces weight, size and cost of the line interface transformer and thereby of the DSL modem.

According to another aspect of the present invention there is provided for use in a DSL modem, a line interface transformer having any of the line interface transformer features set out above.

According to another aspect of the present invention there is provided a method of transmitting electronic data over a transmission line, which method comprises the steps of placing said electronic data on said transmission line using a line interface transformer set out above.

According to yet another aspect of the present invention there is provided a method of manufacturing DSL modem, which method comprises the step of a inserting a line interface transformer as set out above and electrically connecting said transformer thereto. This method might be performed by a telephone company who transmit data (e.g. web pages, e-mail, files) to users utilising a DSL connection. The data may be digital data and the method may further comprise the step of transmitting this data via the line interface transformer in a modulated form such as by DMT and/or QAM. The method may further comprise the step of transmitting the data via the line interface transformer over a number of carrier frequencies. In one embodiment the carrier frequencies are spaced apart over a bandwidth, which may be approximately 2 MHz, from about 26 kHz to 2.2 Mhz. Preferably the digital data is transmitted via the transformer using an xDSL signal, such as ADSL, ADSL2 and ADSL2+.

According to another aspect of the present invention there is provided a coreless transformer for passing a low frequency band digital data signal between about 10 kHz and 20 MHz, which transformer comprises a primary circuit and a secondary circuit having a number of turns such that said transformer comprises a plurality of layers, each layer having all primary or all secondary conductors, there being a combination of said number of turns and a number layers sufficient to obtain a transformer action for passing said digital data signal from said primary circuit to said secondary circuit over said frequency band. The coreless transformer may be provided with any of the damping means features mentioned above. Furthermore suitable embodiments of the transformer may have application for passing frequencies higher than 2.5 MHz.

Preferably, said layer extends radially outwardly from a centre of said transformer. Thus the layer may be considered to define a plane, although it will be appreciated of course that the primary and secondary circuits are three-dimensional and will contain the plane but not lie exclusively within it.

Advantageously, layers of said primary circuit are adjacent one another to form a primary circuit stack, and layers of said secondary circuit are adjacent one another to form a secondary circuit stack, the arrangement being such that said primary circuit stack and said secondary circuit stack are stacked one next to the other to facilitate said transformer action.

Preferably, layers of said primary circuit are interleaved with layers of said secondary circuit, the arrangement being such that there are alternating layers of said primary and secondary circuits.

Advantageously, said alternating layers comprise single layers of said primary and secondary circuits.

Preferably, a separation between conductors in each layer is between about 0.02 mm and 0.075 mm.

Advantageously, the separation between each layer is between about 0.02 mm and 0.2 mm.

Preferably, there are at least ten layers and between about 50 and 70 turns of each circuit, with 60 giving good results.

According to another aspect of the present invention there is provided an electrical circuit comprising a coreless transformer as set out above. This has been found to provide useful signal transfer properties in DSL frequency band, currents and voltages. It will be appreciated that the number of turns and number of layers may be varied by one skilled in the art whilst still achieving the transformer action necessary to pass a DSL signal. However, good signal filtering techniques in a DSL modem may permit the number of turn/number of layers to be reduced, providing the substantially linear transfer characteristics are maintained over the DSL frequency band of interest. Furthermore, different manufacturing techniques may result in different number of turns/layers required to achieve the same result. For example hand or machine winding techniques with insulated wires may permit there to be slightly fewer turns/layers since the wires are relatively close together compared to PCB manufacturing techniques. In PCB since the conductive tracks are not insulated, spacing between the tracks needs to be larger to inhibit the chances of a short circuit.

According to another aspect of the present invention there is provided an electrical circuit comprising a coreless transformer as set out above. The circuit may be a DSL modem circuit embodied in a stand-alone unit or PC card for example.

For a better understanding of the present invention reference will now be made by way of example only to the accompanying drawings in which:

FIG. 1 is a schematic graph of frequency vs. amplitude showing the frequency bands used by POTS and ADSL;

FIG. 2 is a block diagram of two ADSL modems in accordance with the present invention connected by a twisted pair;

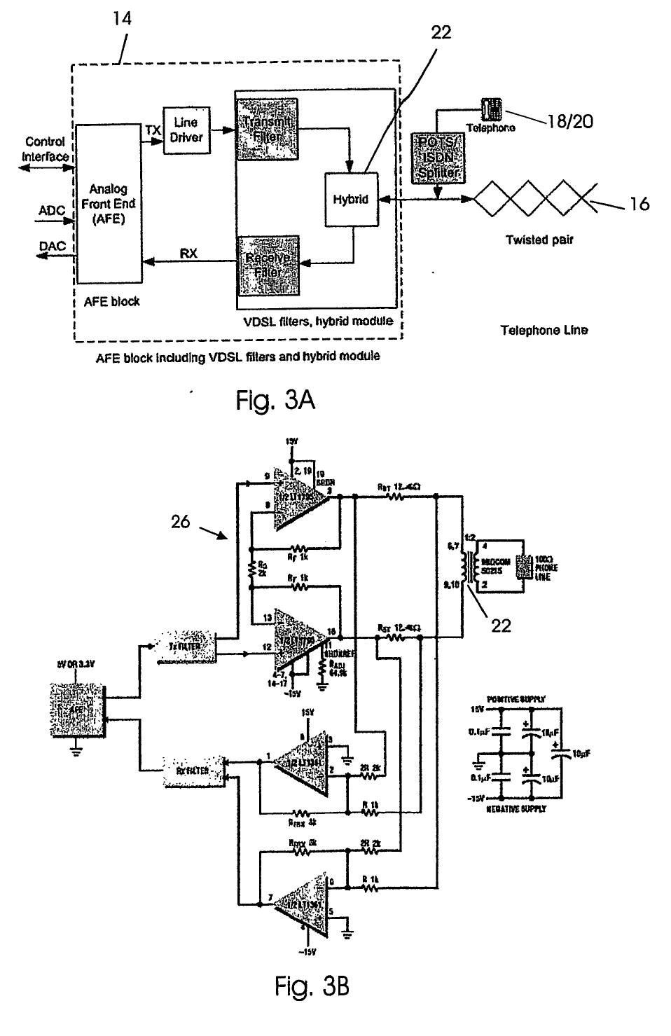

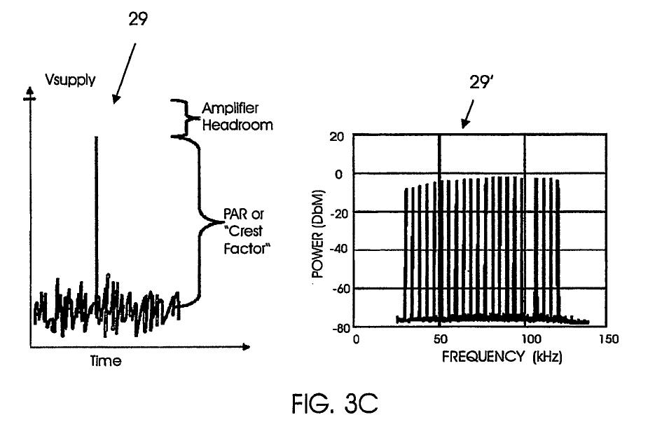

FIG. 3A shows further detail of one of the ADSL modems in FIG. 2;

FIG. 3B is a schematic circuit diagram of part of a DSL modem circuit showing the location of the line interface transformer;

FIG. 3C is two graphs illustrating the nature of a DSL signal;

FIG. 4 is a graph of frequency vs. amplitude for a standard DSL transformer over the ADSL bandwidth;

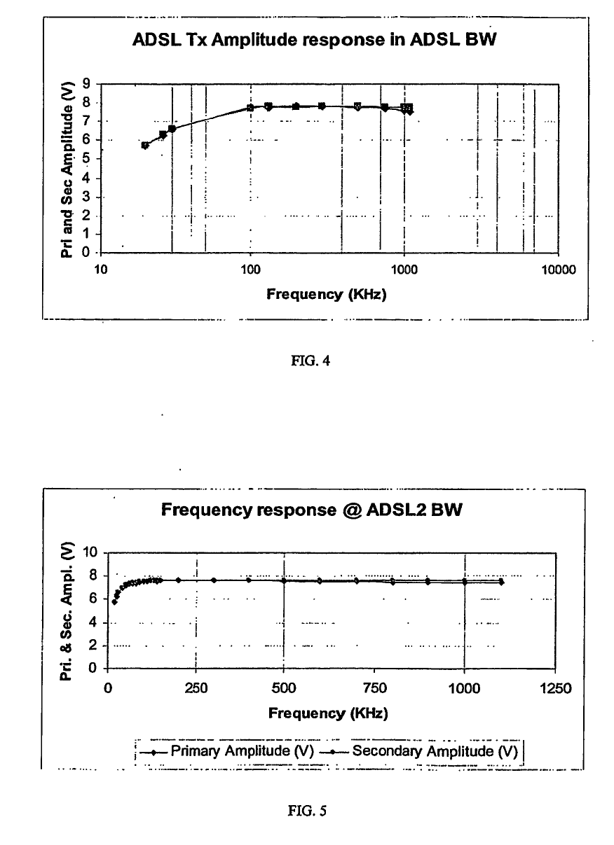

FIG. 5 is a graph of frequency vs. amplitude for a standard DSL transformer over the ADSL2 bandwidth;

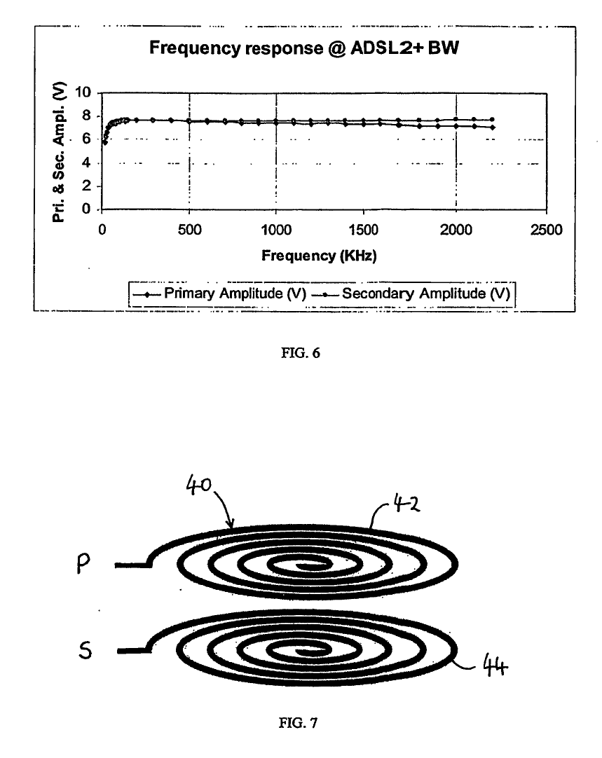

FIG. 6 is a graph of frequency vs. amplitude for a standard DSL transformer over the ADSL2+ bandwidth;

FIG. 7 is a schematic perspective view of a first embodiment of a transformer in accordance with the present invention;

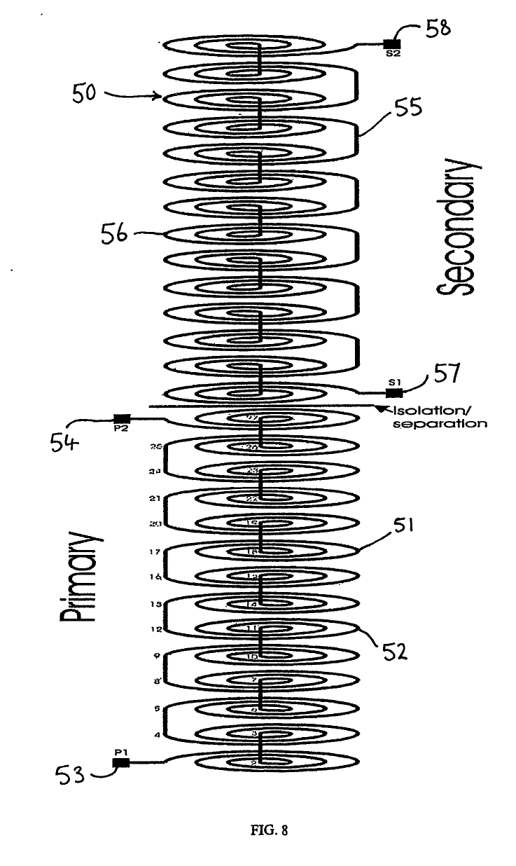

FIG. 8 is a schematic perspective view of a second embodiment of a transformer in accordance with the present invention;

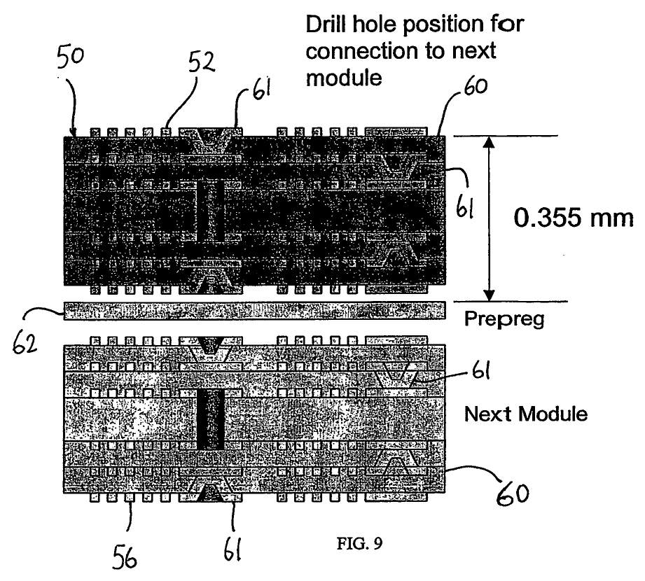

FIG. 9 is a schematic cross-section through two PCB modules for constructing a transformer similar to that in FIG. 8;

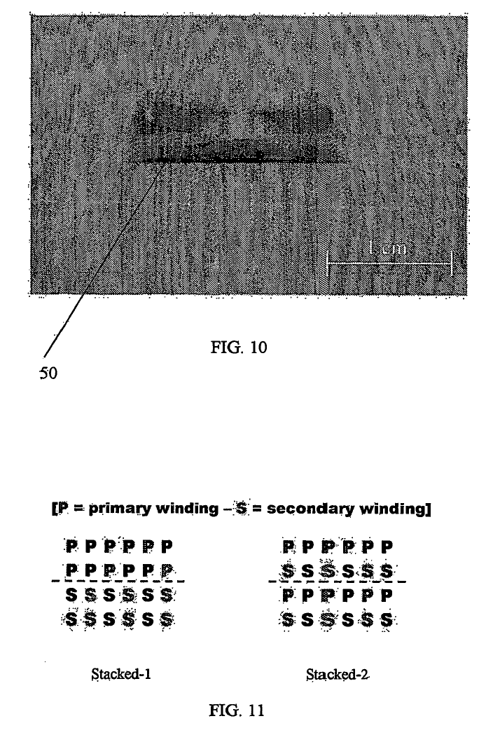

FIG. 10 is photograph of the PCB transformer of FIG. 8;

FIG. 11 is a schematic cross section through two conductor structures according to the present invention;

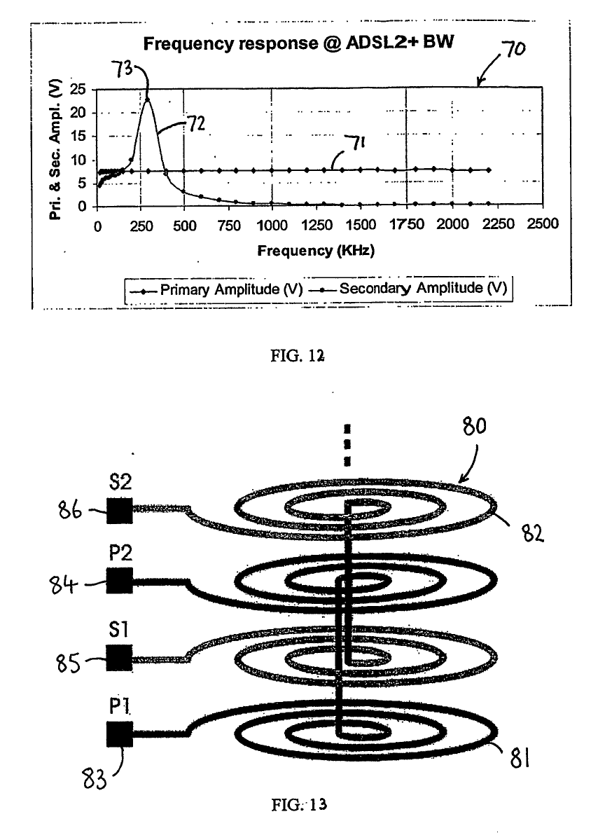

FIG. 12 is a graph of frequency vs. amplitude for the transformer of FIG. 8 over the ADSL, ADSL2 and ADSL2+ bandwidths;

FIG. 13 is a schematic perspective view of a third embodiment of a transformer in accordance with the present invention;

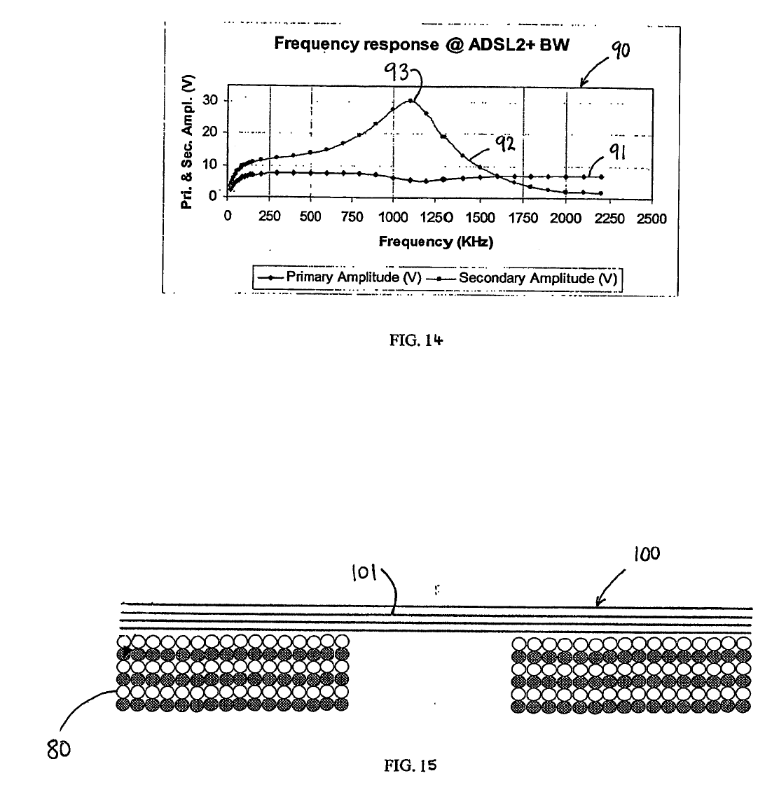

FIG. 14 is a graph of frequency vs. amplitude for the transformer of FIG. 13 over the ADSL, ADSL2 and ADSL2+ bandwidths;

FIG. 15 is a schematic perspective view of a fourth embodiment of a transformer in accordance with the present invention;

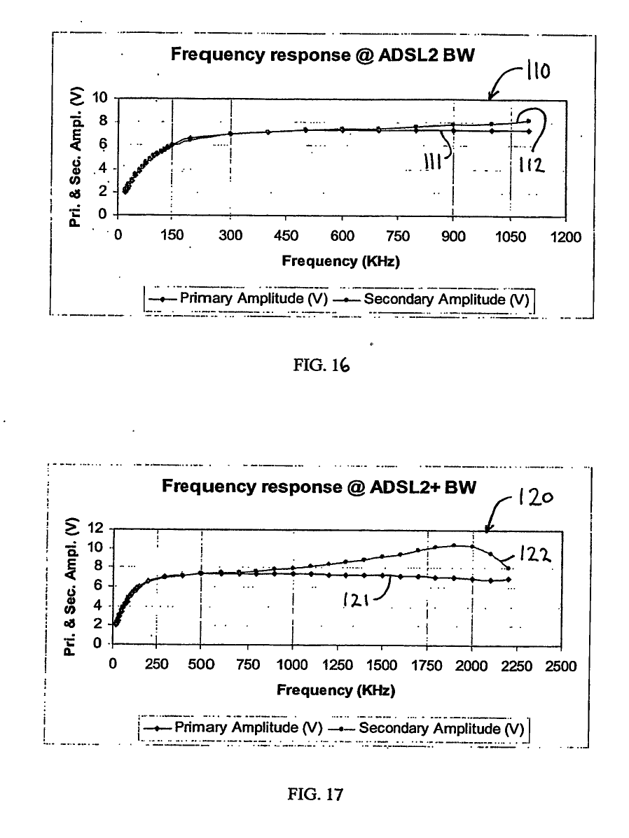

FIG. 16 is a graph of frequency vs. amplitude for the transformer of FIG. 15 over the ADSL2 bandwidth;

FIG. 17 is a graph of frequency vs. amplitude for the transformer of FIG. 15 over the ADSL2+ bandwidth;

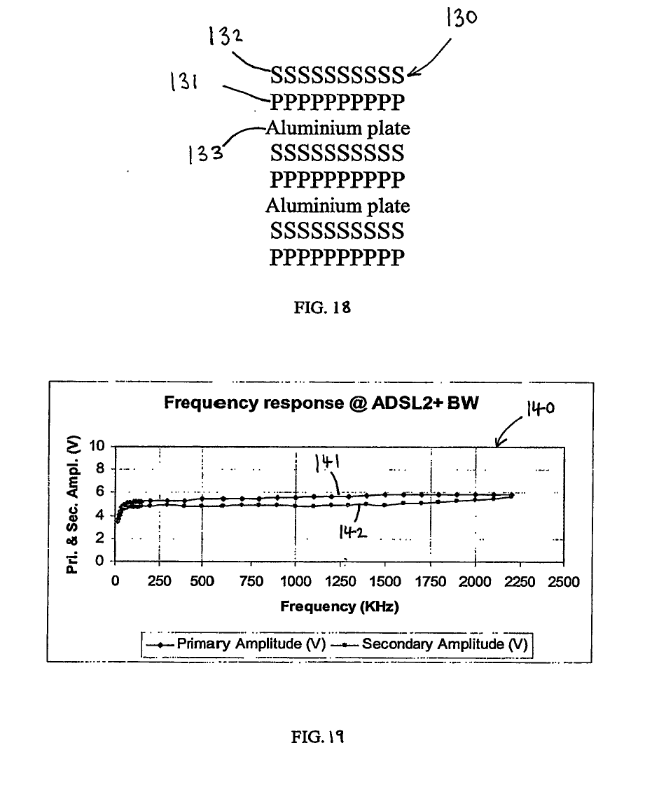

FIG. 18 is a schematic representation of cross-section through a fifth embodiment of a transformer according to the present invention; and

FIG. 19 is a graph of frequency vs. amplitude for the transformer of FIG. 18 over the ADSL2+ bandwidth.

Referring to FIGS. 2 and 3A an ADSL generally identified by reference numeral 10 is established between two modems 12, 14 over a twisted pair 16 of copper wire. In functional terms the modems 12, 14 are identical and thus only one will be described in detail. The modem 12 comprises a low pass filter 18 for filtering the POTS voice frequency band (˜0-4 kHz) and a high pass filter 20 for filtering the ADSL frequency band (˜26 kHz-1.1 MHz). A wideband transformer 22 comprising a wire-wound three dimensional ferrite core lies downstream of the high pass filter 20 and serves to isolate the remaining downstream circuitry from the twisted pair 16 as described above. An ADSL chipset 24 receives the ADSL signal (i.e. frequencies above ˜26 kHz) from a secondary winding (not shown) of the wideband transformer 22. The ADSL chipset 24 serves to amplify and decode the ADSL signal for subsequent processing. The ADSL chipset 24 passes the processed ADSL signal either to an Internet Service Provider (ISP) or to a Personal Computer (PC), depending on the location of the modem. The low pass filter 18 passes the low frequency POTS signal either to a Public Switched Telephone Network (PSTN) or a telephone depending on whether the modem is at the CO or CP. FIG. 3B shows the location of the wideband transformer 22 in a typical ADSL circuit 26 that is part of both the modems 12, 14.

Referring to FIG. 3C the nature of the DSL signal is illustrated by two graphs 29 and 29′. ADSL relies on Discrete MultiTone (DMT) modulation to carry digital data over phone lines. The ADSL spectrum occupies frequencies from ˜26 kHz to 1.1 MHz while reserving the space below 20 kHz for voice signals (see FIG. 1). DMT signals viewed in the time domain appear as a pseudo-random noise signal and graph 29 suggests that DMT signals typically produce low rms voltage levels. However, xDSL line driver amplifiers (see FIG. 3C) must be capable of delivering peak voltages caused by the finite probability that many of the carriers in several sub-bands or tones may align in phase. Dynamic headroom allowances must be made in order to reproduce these large peaks when they occur.

DMT modulation appears in the frequency domain as power contained in several individual frequency sub-bands, sometimes referred to as tones or bins, each of which are uniformly spaced in frequency 4.3125 kHz apart (see graph 29′). A uniquely encoded Quadrature Amplitude Modulated (QAM)-like signal occurs at the centre frequency of each sub-band or tone. In the frequency domain depicted an upstream DMT signal produces peaks at each sub-band of approximately −1 dBm. Combining the power in each sub-band, a total power of 13 dBm is delivered to the load. Maintaining enough voltage headroom so that the amplifier can deliver undistorted peaks is challenging. The ratio of these infrequent peaks to the rms level in a DMT waveform is known as the peak to average ratio (PAR) or “crest factor”. A crest factor of 5.3 is typically used when designing the line driver hybrid for ADSL modems.

Difficulties will exist when decoding the information contained in DMT sub-bands if a QAM signal from one sub-band is corrupted by the QAM signal(s) from other sub-bands. Intermodulation distortion is the primary concern as typical xDSL downstream DMT signals may contain as many as 256 carriers (sub-bands or tones) of QAM signals. In xDSL modems DMT signal fidelity is required so that demodulators can accurately detect analogue signal amplitudes. ADCs can then accurately translate magnitude and sign information contained within each sub-band into corresponding digital bit streams. Bit errors occur when error-correction schemes cannot recover a piece of corrupted data that may have been caused by a lack of DMT signal fidelity. In short, DMT signal fidelity must be maintained through the ADSL line driver and bridge hybrid in order to preserve performance, minimise data corruption and improve data transfer rates in DSL modems.

Transformers find many applications where the current and voltage capabilities of active devices need to be matched to different load impedances. Since a transformer reflects the secondary load impedance back to the primary by the square of the turns ratio, the current drive demands increase while the voltage drive decreases.

ADSL modems require analogue bridge hybrid circuits to provide several important functions. The bridge hybrid transmits and receives data contained in analogue signals over the telephone lines, separates the receive signal from the transmitted signal, provides proper line termination impedance and isolates the line from the modem. It can also be designed to optimise power delivered to the line.

The functional requirements of the wideband transformer 22 within this context are set out in an ADSL standard. The requirements are given in the table below:

TABLE
ADSL requirements

| | | Full Rate ADSL | Full Rate ADSL |
|---|---|---|---|
| Parameter | | Downstream | Upstream |
| Characteristics | Channels Used | 31 to 256 | 6 to 30 |
| | Frequency Band (KHz) | 133.7 to 1104 | 25.8 to 129.4 |
| | Bandwidth (KHz) | 970.3 | 103.5 |
| | Power Spectral Density, PSD (dBm/Hz^{1/2}) | −40 | −37 |
| | Line Power (dBm) | 20 | 13 |
| | RMS Line Power (mW) | 100 | 20 |
| | Line Impedance (Ω) | 100 | 100 |
| Electrical | RMS Line Voltage (V) | 3.1 | 1.4 |
| requirements | RMS line Current (mA) | 31 | 15 |
| | Peak-to-Average Ratio, PAR | 5.3 | 5.3 |
| | Peak Line Voltage (V) | 16.5 | 7.6 |
| | Peak-to-Peak Line Voltage (V) | 33 | 15.2 |
| | Peak Line Current (mA) | 170 | 76 |
| | Peak Line Power (mW) | 2725 | 580 |
| Theoretical date rates | Bits/Symbol | 15 | 15 |
| | Bits/Channel (Kbits/s) | 60 | 60 |
| | Max Data rate for Channel Used | 13.5 Mb/s | 1.4 Mb/s |

Thus, the wideband transformer 22 must pass the signal from the twisted pair 16 substantially without distortion, loss in amplitude, phase shifts and harmonics across the ADSL frequency band. In particular, the modem 14 sends signals representing electronic data to the telephone company modem 12 between 26 KHz and 138 KHz, and receives signals from 138 KHz up to 1.1 MHz. Referring to FIGS. 4, 5 and 6 frequency response graphs for the wideband transformer 22 (APC Limited model 41199 0040C) over the ADSL, ADSL2 and ADSL2+ frequency bands are generally identified by reference numerals 30, 32 and 34 respectively. Each graph 30, 32 and 34 comprises a response curve 30a, 32a, 34a for a primary winding of the transformer and a response curve 30b, 32b, 34b for a secondary winding of the transformer with a test signal of 7.5V throughout the various bandwidths. The frequency response of the secondary winding is relatively flat between about 100 kHz and the upper end of each range (i.e. 1 MHz, 1.2 MHz and 2.2 MHz respectively). However, between about 20 kHz and 100 kHz the output voltage from the secondary winding rolls off as frequency decreases. This is due to the flux linkage problem at low frequency mentioned in the introduction In particular, as frequency decreases the skin depth increases i.e. assuming everything else remains constant, the amount of material in the winding needed to absorb 63% of the available energy contained in the magnetic flux increases. If a greater proportion of energy transfer is required at this lower frequency, the accepted solution in the art would be either to increase the amount material in the secondary winding and/or increase the size of the iron core to concentrate the magnetic flux. The applicant has found a way the remove the iron core of typical DSL transformers without a substantial loss in flux linkage.

Referring to FIG. 7, a first embodiment of a transformer generally identified by reference numeral 40 comprises two spiral circuits: a primary circuit 42 and a secondary circuit 44. It will be noted that there is no ferrite core. Each circuit defines a plane, with each plane parallel to the other, and each circuit is wound to form an Archimedean spiral (the spacing between turns of each circuit is greatly exaggerated for clarity). Each circuit is etched on a laminate circuit board (not shown) and comprises copper track 45 of approximately 0.075 mm width and 0.05 mm height above the circuit board. Each circuit has 60 turns and is of approximately 18.29 mm diameter. The horizontal spacing between the tracks of each circuit 42, 44 (as measured between closest edges) is 0.075 mm. The overall diameter of the coil is 20 mm. The specification of a single layer of the transformer 40 is given in the table below:

Specifications of the single coil used for the layers

| | |
|---|---|
| Type: | Stacked Transformer |
| Manufacture: | PCB technology |
| Dimensions: | 18.288 mm diameter |
| Number of turns: | 60 |
| Coil thickness: | 0.0762 mm |
| Separation: | Air gap |
| Coupling: | Vertical magnetic coupling between layers |

Referring to FIG. 8 a second embodiment of a transformer generally identified by reference numeral 50 comprises a stack 51 of fourteen layers of primary circuits, each layer having 60 turns. The primary circuits 52 are stacked with their planes substantially parallel to one another (shown spaced apart in the Figure for clarity). The spacing between each primary circuit 52 is about 0.07 mm Each of the primary circuits 52 is connected at its radially innermost end to the radially innermost end of a primary circuit 52 directly above, and at its radially outermost end to the radially outermost end of a primary circuit 52 directly below and vice versa, whereby a continuous conductive path (i.e. a series connection between the primary circuits) is provided between an input terminal 53 and an output terminal 54.

The transformer 50 further comprises a stack 55 of fourteen layers of secondary circuits 56 (only fourteen shown), each layer having 60 turns. The secondary circuits 56 are stacked with their planes substantially parallel to one another (shown spaced apart in the Figure for clarity). The spacing between each secondary circuit 56 is about 0.07 mm. Each of the secondary circuits 56 is connected at its radially innermost end to the radially innermost end of a secondary circuit 56 directly above, and at its radially outermost end to the radially outermost end of a secondary circuit 56 directly below and vice versa, whereby a continuous conductive path (i.e. a series connection between the secondary circuits) is provided between an input terminal 57 and an output terminal 58.

At their closest point the spacing between the stack 51 and the stack 55 is about 0.1 mm. The transformer operation and frequency response improves with the number of layers, with between 20 and 40 layers each of 60 turns producing good results for DSL applications.

Referring to FIG. 9 the transformer 50 is shown in PCB circuit form. Each PCB layer holds one primary or secondary circuit having 60 turns and measures 20 mm by 20 mm and is 0.355 mm thick (before pressing) i.e. it has a high aspect ratio (diameter:height). In manufacture six PCB layers are stacked, heated and pressed to form a module 60 of primary or secondary circuits. The modules 60 of primary circuits 52 and secondary circuits 56 may be stacked on top of one another to form the transformer 50 with the desired number of circuit layers. The transformer 50 comprises five modules of primary circuits 52 and five modules of secondary circuits 56, and therefore sixty circuit layers. Within each module 60 primary circuits 52 (and secondary circuits 56) are connected to the corresponding circuit on the layer beneath either near the centre of the PCB or near the edge of the PCB by connections 61. Furthermore the connection 61 between each PCB layer alternates between a centre position and an edge position. The separation between each module 60 is 0.2 mm and is provided by PCB laminate 62 to insulate the circuits of one module 60 from the circuits of another. A photograph of the PCB transformer 50 is shown in FIG. 10 from which it is apparent that it is “quasi-planar”. The small size is immediately apparent, particularly in terms of height. The PCB transformer 50 in FIG. 10 has dimensions of 2.3 mm by 20 mm by 20 mm (H×W×D) and weighs 1.9 g compared to 6.3 g for a typical ADSL transformer. Such a weight saving (approximately 70%) offers significant advantages to industry in terms of manufacturing and transportation costs.

The aim of this geometric arrangement of the primary circuit 52 and secondary circuit 56 is to achieve the transformer action mainly via global coupling (i.e. coupling of the vertical magnetic flux component generated by the primary circuits 42 with the secondary circuits 44) rather than local magnetic flux transference between neighbouring tracks of the circuits. In particular, referring to FIG. 12 two primary circuit and secondary circuit conductor patterns are illustrated as “Stacked-1” and “Stacked-2”. Each of these arrangements comprises a three dimensional structure having stacked layers of primary and secondary circuits. In the case of Stacked-1 primary circuits are stacked one on top of another to form a primary circuit stack, and secondary circuits are stacked one on top of another to form a secondary circuit stack. The two stacks are then mounted one on the other. In the case of Stacked-2 primary circuits are alternately stacked on top of secondary circuits to form an interleaved structure.

The particular advantage of the three dimensional winding structure is that inductance of the primary circuit is increased and the flux linkage to the secondary circuit is improved, even at the low frequencies of DSL. Furthermore the structure provides low Q factor whereby a good frequency response is present over the whole ADSL frequency range. A particular advantage of the Stacked-2 structure is that each primary circuit has a secondary circuit above and below. The secondary wires (or tracks) are in such close proximity to the primary wires (or tracks) that a very good local magnetic flux linkage is obtained Unlike the Stacked-1 arrangement where compared to the inner layers the outer layers of the stack of primary circuits are more distant from the secondary stack of circuits, the Stacked-2 arrangement has the primary and secondary placed symmetrically. Therefore the magnetic flux throughout the body of transformer 50 is more homogeneous in that the vertical (i.e. perpendicular to the plane defined by each circuit) component of the magnetic flux is dominant and there is smaller component of horizontal magnetic flux. Since neighbouring parts of each circuit are horizontally spaced it is important to reduce the expanding/collapsing horizontal component of flux to reduce self-induction.

Furthermore as viewed on a larger scale the structures help to reduce parasitic capacitance between primary wires and secondary wires. When wires are wound to form these structures, the separation between the wires is simply the width of insulation between the two conductors (typically ˜0.02 mm). When using PCB manufacturing techniques the spacing will be slightly greater (˜0.075 mm) as the conductive tracks are not enclosed by insulation. Precaution needs to be taken against short-circuit as since the isolation safety function of a line interface transformer is paramount.

Referring to FIG. 12 a graph generally identified by reference numeral 70 shows the frequency response of the transformer 50 over the ADSL2+ frequency bandwidth (which comprises the ADSL and ADSL2 bandwidths). An input voltage 71 of 7.5V was input to the primary circuits 42 generating an output voltage 72 from the secondary circuits by transformer action. A clear resonance 73 is seen in the output voltage 72 at about 300 kHz, which then drops exponentially to zero over the frequency range of 300 kHz to about 1.25 MHz. The resonance in the secondary output voltage 72 is particularly undesirable since to obtain minimum bit error rates at the receiver, a DSL line interface transformer should ideally have 1:1 voltage transfer characteristics over the entire DSL frequency range. Signal attenuation is tolerable providing the loss is substantially the same over the frequency range of interest (i.e. the attenuation is independent of input frequency). Accordingly, it is essential that resonance and frequency-dependent attenuation be mitigated if the transformer 50 is to have practical application as a line interface (or wideband) transformer. This can be achieved by altering the inductance and/or capacitance properties of the transformer to flatten the frequency response (e.g. by shifting the resonance out of the frequency band of interest). In the present case the present invention provides these adjustments by altering geometry of the transformer (such as number of turns, number of layers, spacing between layers, etc.). Additionally or alternatively another circuit component (e.g. capacitor) can be used in conjunction with the transformer to this end.

Referring to FIG. 13 a second embodiment of a transformer generally identified by reference numeral 80 comprises an interleaved structure of primary circuits 81 and secondary circuits 82. Primary circuits 81 are stacked on top of secondary circuits 82 in a plane-parallel manner such that each primary circuit 81 has a secondary circuit 82 on either side, and vice-versa. Electrical connections are made between alternate layers such that the primary circuits are connected in series in a first circuit to terminals 83, 84, and the secondary circuits are connected in series in a second circuit to terminals 85, 86. The interleaved structure is intended to improve the coupling between primary and secondary circuits, thereby changing the capacitance characteristics of the transformer and reducing resonance effects at frequencies in the DSL bandwidth. Additionally or alternatively a capacitor may be placed in parallel with the transformer 80 (or any other transformer described herein) to shift the resonance out of the frequency bandwidth of interest Over the DSL bandwidths the coefficient of coupling of the transformer 80 is high at about 0.9. A particular advantage of this arrangement is that capacitive coupling between the primary and secondary circuits is reduced, enabling the transformer 80 to be used in higher frequencies, such as ADSL2+.

The PCB construction of the transformer 80 is similar to that described above in connection with transformer 50 to which reference is made. The transformer 80 has 60 turns per circuit layer. Ideally there should be at least 20 primary circuit layers and 20 secondary circuit layers if the transformer is to be used over the ADSL2 bandwidth (i.e. up to about 1.1 MHz); ideally there should be at least 30 primary circuit layers and 30 secondary circuit layers if the transformer 80 is to be used over the ADSL2+ bandwidth (i.e. about 2.2 MHz). The separation between the layers should as described above.

Referring to FIG. 14 a graph generally identified by reference numeral 90 shows the frequency response of a handmade version of the transformer 80 having five primary circuit layers 81 and five secondary circuit layers 82 over the ADSL2+ frequency bandwidth (which comprises the ADSL and ADSL2 bandwidths). An input voltage 91 of 7.5V was input to the primary circuits 81 generating an output voltage 92 from the secondary circuits 82 by transformer action. Over the ADSL/ADSL2 frequency bandwidth (i.e. up to 1.1 MHz) the frequency response of the transformer 80 is relatively flat with a resonance 93 appearing in the output voltage 92 at an input frequency between 750 kHz and 1.1 MHz. The resonance 93 peaks at about 1.1 MHz the secondary circuit 82 outputting four times input voltage, and then the output voltage 92 falls away at input frequencies greater than this. At input frequencies greater than about 1.6 MHz the output voltage 92 is lower than the input voltage 91. These characteristics may not be satisfactory for DSL application.

The applicant considered this problem and found, surprisingly, that using a electromagnetic shielding member or members on one or both sides and/or within the layers of the transformer reduced the resonance/attenuation problem. Surprisingly, it was found experimentally that using a metallic member on one side only produced good results. Surprisingly, dispersing such metallic members throughout the layers of the transformer produced even better results. The metallic member may be in the form of a plate, foil or continuous conductive track for example. The shape of the metallic member should ideally, although not essentially, be the same as a layer of the transformer, in this case substantially circular. The thickness of the metallic member should be less than about 0.2 mm and the number of layers can be between 1 and 10, with 5 layers being useful for DSL applications.

Referring to FIG. 15 a fourth embodiment of a transformer generally identified by reference numeral 100 comprises the transformer 80 and four layers 101 of aluminium foil in abutment with one another and positioned at one side of the transformer 80, so that planes defined by the layers 101 are substantially parallel to the planes defined by the circuit layers of the transformer 80. Each piece of aluminium foil is 0.05 mm thick and is cut in the form of a circle to match the footprint of the transformer 80, although the same shape is not essential. It will be noted that the inner turns of each layer have been omitted. These inner ten turns of each layer contribute very little to the inductance of the transformer and therefore their omission does not greatly affect the properties of the transformer 80. However, some manufacturing advantage is obtained and parasitic capacitance between the layers is reduced. Any of the transformers described herein may have a number (e.g. 5-10) of the inner turns omitted.

In use, the function of the layers 101 is to generate eddy currents via the varying magnetic field around the transformer 80 and reduce the resonance effects. By Lenz's law these eddy currents oppose the variation in magnetic flux of the transformer 80. Therefore the layers 101 dampen any resonant peaks by opposing the higher voltages generated in the secondary circuit 82. When the output signal is attenuated, eddy currents in the layers 101 try to maintain a higher voltage in the secondary circuit. In the DSL frequency range, the skin depth in which 1/e or 63% of the magnetic field is absorbed is between about 0.5 mm and 0.086 mm for aluminium. Thus, by appropriate choice of the overall thickness of the layers 101, it is possible to ensure that at low frequencies the eddy currents are small and have a corresponding effect on the secondary output voltage; whereas at higher frequencies where the resonance was observed, the eddy currents have a much larger magnitude and therefore dampen the resonance and resist attenuation. In this way the frequency response curve of the transformer 80 can be flattened over the DSL frequency range.

Referring to FIG. 16 a graph generally identified by reference numeral 110 shows the frequency response of a hand-wound version of the transformer 100 comprising ten circuit layers (five primary, five secondary) over the ADSL/ADSL2 frequency bandwidth. An input voltage 111 of 7.5V was input to the primary circuits generating an output voltage 112 from the secondary circuits 82 by transformer action. The output voltage 102 is substantially flat over most the ADSL/ADSL2 frequency range and in particular the large resonance seen at the upper end has been greatly damped.

Referring to FIG. 17 a graph generally identified by reference numeral 120 shows the frequency response of the hand-wound transformer 100 over the ADSL2+ frequency bandwidth. An input voltage 121 of 7.5V was input to the primary circuits generating an-output voltage 122 from the secondary circuits by transformer action. The output voltage 122 is substantially flat over most of the ADSL2+ frequency range and in particular the large resonance seen at mid-range has been greatly damped (it is now only about 30% higher than the input voltage 121 rather than 400% as in FIG. 15) and pushed to the upper end of the range. The small resonance at 2 MHz can be moved out of the ADSL2+ frequency band by addition of more circuit layers e.g. up to about thirty of each type.

Referring to FIG. 18 a fifth embodiment of a transformer generally identified by reference numeral 130 comprises alternating layers of a primary circuit 131, a secondary circuit 132 and an aluminium plate 133 to form six circuit layers divided by two aluminium plates 133. Each aluminium plate 133 has dimensions similar to that described above. Each primary circuit layer 131 has 60 turns and each secondary circuit layer 132 has 60 turns. The transformer 130 was hand wound (although this structure is amenable to any suitable automated manufacturing process) and the separation between the conductors of each circuit and between each layer was two insulation thicknesses. The electrical properties of the transformer 130 are:
Lₚᵣᵢ=1.33 mH
L_{sec}=1.39 mH
Rₚᵣᵢ=3.49 Ω
R_{sec}=3.55 Ω
Cₚᵣᵢ=C_{sec}=19 μF

Referring to FIG. 19 a graph generally identified by reference numeral 140 shows the frequency response over the ADSL2+ frequency bandwidth of the transformer 130. An input voltage 141 of 7.5V was input to the primary circuits generating an output voltage 142 from the secondary circuits by transformer action. The transformer 130 shows a very flat frequency response over the ADSL2+ bandwidth, with substantially frequency-independent attenuation. This is very surprising in view of the small number of layers. The addition of more layers to the transformer 130, separated by aluminium plates 133, would reduce the amount of attenuation and extend the flat frequency response of the transformer into higher frequencies. In particular, the addition of more primary and secondary circuit layers increases the inductance of the transformer 130 and thereby reduces the attenuation of the output voltage 142. However, there is a corresponding increase in the resonance effect seen at some frequencies in the output voltage 142. If more aluminium plates 133 are added, any resonance is shifted to higher frequencies, but the attenuation of the output voltage 142 is increased. Thus a balance must be struck between number of circuit layers and the number of aluminium plates 133. The applicant has found the combination described above produces good results. For DSL applications the pattern of primary circuit, secondary circuit, aluminium plate may be repeated until there are between 10 and 20 layers each of primary and secondary circuits. Such an arrangement may be useful for DSL applications in the tens of MHz e.g. VDSL.

In one alternative the aluminium plates/foils may be replaced by a passive circuit i.e. a spiral circuit similar to the primary and secondary circuits, but which is short-circuited. Such a passive circuit would perform the same function as the aluminium plates, but offers manufacturing advantage particularly for PCB where a layer would simply be short-circuited rather than connected to the other primary or secondary circuits.

In another alternative there may be more than one of each type of circuit between the layers of aluminium plate (or whatever other resonance damping means is used).

It will be appreciated that the transformers described herein are amenable to various manufacturing processes including etching, printed circuit board, thin-film deposition and automated machine winding. Such transformers can be produced quickly and cheaply using these methods, with a reduced amount of raw material. The finished product is lighter and smaller than conventional DSL transformers.

Variations in the diameter and material of wires (or width of track), spacing between the wires, spacing between layers, number of turns of each circuit, number of layers, and thickness, number of layers, and position of metallic member, all affect performance of transformers as described herein. However, provided with the principle of forming a transformer with a stacked structure as described herein, the skilled person is able to adjust the various parameters above to obtain the desired low frequency wideband signal transmission characteristics whilst reducing weight and space.

1-36. (canceled)

37. A coreless transformer for passing a low frequency band waveform between about 10 kHz and 20 MHz, which transformer comprises a primary circuit and a secondary circuit having a number of turns such that said transformer comprises a plurality of layers, each layer having all primary or all secondary conductors, there being a combination of said number of turns and a number layers sufficient to obtain a transformer action for passing said waveform from said primary circuit to said secondary circuit over said frequency band.

38. A coreless transformer as claimed in claim 37, wherein said layer extends radially outwardly from a centre of said transformer.

39. A coreless transformer as claimed in claim 37, wherein layers of said primary circuit are adjacent one another to form a primary circuit stack, and layers of said secondary circuit are adjacent one another to form a secondary circuit stack, the arrangement being such that said primary circuit stack and said secondary circuit stack are stacked one next to the other to facilitate said transformer action.

40. A coreless transformer as claimed in claim 38, wherein layers of said primary circuit are interleaved with layers of said secondary circuit, the arrangement being such that there are alternating layers of said primary and secondary circuits.

41. A coreless transformer as claimed in claim 40, wherein said alternating layers comprise single layers of said primary and secondary circuits.

42. A coreless transformer as claimed in claim 37, wherein a separation between conductors in each layer is between about 0.02 mm and 0.075 mm.

43. A coreless transformer as claimed claim 37, wherein the separation between each layers is between about 0.02 mm and 0.2 mm.

44. A coreless transformer as claimed in claim 37, wherein there are at least ten layers.

45. An electrical circuit comprising a coreless transformer according to claim 37.

46. A digital subscriber line (DSL) modem comprising a line interface transformer having a primary circuit for coupling to a transmission line and a secondary circuit for outputting a signal transmitted over said transmission line, each circuit being formed of a continuous electrically conductive material and in which the primary circuit defines a first plane and the secondary circuit defines a second plane, said first and second planes substantially parallel to one another.

47. A DSL modem as claimed in claim 46, wherein said first plane is spaced-apart from said second plane.

48. A DSL modem as claimed in claim 46, wherein said line interface transformer comprises alternating layers of said primary circuit and said secondary circuit.

49. A DSL modem as claimed in claim 46, wherein there are a plurality of first and second planes each plane forming a layer and wherein said primary circuit comprises a plurality of substantially parallel layers and said secondary circuit comprises a plurality of substantially parallel layers.

50. A DSL modem as claimed in claim 49, layers of said primary circuit adjacent one another and layers of said secondary circuit adjacent one another, said primary and secondary circuits separated by a gap.

51. A DSL modem as claimed in claim 50, wherein said primary circuit layers form a primary circuit stack and said secondary circuit layers form a secondary circuit stack, said primary circuit stack and said secondary circuit stacked one adjacent the other.

52. A DSL modem as claimed in claim 50, wherein layers of said primary circuit are interleaved with layers of said secondary circuit.

53. A DSL modem as claimed in claim 49, wherein the separation between said layers is not more than 0.5 mm.

54. A DSL modem as claimed in claim 49, wherein layers of said primary circuit and/or said secondary circuit are connected in series or parallel.

55. A DSL modem as claimed in claim 49, further comprising at least ten layers of said plurality of substantially parallel layers of said primary circuit, and at least ten layers of said plurality of substantially parallel layers of said secondary circuit.

56. A DSL modem as claimed in claim 46, wherein a number of turns of each circuit is at least ten.

57. A DSL modem as claimed in claim 46, wherein said primary circuit and said secondary circuit are in the form substantially parallel spirals of the conductive material defining substantially different planes.

58. A DSL modem as claimed in claim 46, having an aspect ratio defined as diameter to width of 5:1 or more.

59. A DSL modem as claimed in claim 46, wherein said line interface transformer does not comprise ferromagnetic core.

60. For use in a DSL modem, a line interface transformer having any of the line interface transformer features of claim 46.

61. A method of transmitting electronic data over a transmission line, which method comprises the steps of placing said electronic data on said transmission line using a line interface transformer as claimed in claim 60.

62. A method of manufacturing DSL modem, which method comprises the step of a inserting a line interface transformer according to claim 60 and electrically connecting said transformer thereto.
